(19) United States
(12) Patent Application Publication
(10) Pub. No.: US 2018/0090025 A1
(43) Pub. Date: Mar. 29, 2018

(54) A TEACHING AND ASSESSMENT SYSTEM AND METHOD

(71) Applicant: DEVELOPING EXPERTS LIMITED, Norwich, Norfolk (GB)

(72) Inventor: Sarah Mintey, Norfolk (GB)

(21) Appl. No.: 15/526,009

(22) PCT Filed: Jan. 19, 2017
(86) PCT No.: PCT/GB2017/050118

§ 371 Date: May 11, 2017

(30) Foreign Application Priority Data
Jan. 20, 2016 (GB) 1601085.2

(51) Int. Cl. G09B 7/04; G06T 13/40

(52) U.S. Cl. CPC G09B 7/04; G06T 13/40

(57) ABSTRACT

A method for producing a normalised output of a characteristic of a monitored and developing entity, the method including intermittently retrieving information indicative of a test from an information storage device to an information processing means, communicating information indicative of one or more questions of the test from the processing means to the entity via an audio and/or visual communication provided by a multimedia communication means, communicating information indicative of an audio and/or visual communication from a puppet narrator to the entity via the multimedia communication means, calculating, from recorded information indicative of a response of the entity to the one or more questions and the puppet narrator, with the processing means, a score of attainment of the entity corresponding to the one or more questions of the test, and outputting the score as a measure of attainment of the entity in response to the test.

### FIELD OF THE INVENTION

The invention relates to an academic teaching and progress assessment system and method, in which the monitored entities are human individuals. For example, pupils or students, for whom the characteristic property of academic attainment is achieved through a suite of structured lessons, which are then subsequently assessed in some way so that an historic achievement record for the pupil or student exists; and for which it is intrinsically possible to derive some measure of teaching performance, along with a subsequent measure of academic progress for that or those individuals over time.

Integrated continued professional development resources with a supporting tracking system provide a teacher training development solution that can be monitored through time-stamped videos and supporting questions for each subject unit.

### BACKGROUND TO THE INVENTION

Learning platforms for pupils/students are well known and commercially available.

A known online testing platform is the IXL™ teaching platform. This is a test platform which is designed to support learning subjects, such as mathematics and English. This platform provides a range of tests for both primary and secondary education, whereby these tests are mapped against a national curriculum.

The IXL™ platform assists teachers in tracking the performance of students through the use of online testing.

A disadvantage of the IXL™ system is that there is no resource contained within it for teaching the students/pupil.

Another well-known teaching platform is the Khan Academy™ learning platform. This comprises an online range of teaching units, which have grown organically over a period of time.

A disadvantage of the Khan Academy™ platform is that the content is not sequenced, and there is no subsequent testing of the subject matter being taught. Thus, no emphasis has been placed on the learning mastered by the student/pupil.

It is also known that a stand-in teacher/temporary teacher may be required to take a lesson in a subject which is not their field of expertise, and would therefore be reliant on a set of pre-prepared class notes that have been pre-prepared by a teacher who is an expert in the subject of the lesson. A disadvantage of this teaching method is that the teacher may not be in a position to provide any supplementary information, or answer any questions in relation to the subject matter of the lesson, thus reducing the learning provided by the lesson.

It is an object of the present invention to provide a teaching and assessment system and method, which addresses the above problems.

### SUMMARY OF THE INVENTION

According to a first aspect of the present invention, there is provided a method for producing a normalised output [SCORE] of a characteristic of a monitored and developing entity [STUDENT], said method including the steps of:
Intermittently retrieving information indicative of a test from an information storage device [DATABASE] to an information processing means [SOFTWARE PROGRAM]; and
communicating information indicative of one or more questions of said test from said processing means to said entity via a first audio and/or visual communication provided by a multimedia communication means;
   said method being characterised in that includes the further steps of:
communicating information indicative of an audio and/or visual communication that provides a narrator, which in use, communicates said test to said entity via a second audio and/or visual communication provided by said multimedia communication means;
calculating, from recorded information indicative of a response of said entity to said one or more questions and said narrator, with said processing means, a score of attainment of said entity corresponding to said one or more questions [QUESTIONS] of said test; and
outputting said score as a measure of attainment of said entity in response to said test.

This configuration provides a technical capability, which enables the system to provide a required and test and present to an entity, the entity being a student/pupil, for example, a young child. The narrator may be a puppet narrator.

The use of a puppet narrator communicates the subject matter of the required test to the student/pupil and teacher, to monitor their mastery of a subject unit. The student/pupil will be attracted to the puppet because of its child-like attracting qualities, which retains their attention for prolonged periods; these periods being the duration of the test. Once the entity has been tested, the system then calculates a score which is then stored and correlated to the child for subsequent use. Test scores can be mapped against national frameworks and results can be communicated via a report which shows competence against a set of criteria.

Preferably, a method for producing a normalised output of a characteristic of a monitored and developing entity further comprises the step of retrieving information indicative of the subject matter for providing a correct response to a question if said entity provides an incorrect response to any questions, and communicating said information of correct response to said entity via a third audio and/or visual communication provided by said multimedia communication means.

This configuration provides the system with a technical capability, which enables the system to subsequently retrieve the information and retest the entity in regards to a previously asked question that was answered incorrectly. This provides a means of reiterative learning which refreshes the learning of the entity with the correct subject matter required for the question/test.

The assessment reporting system preferably provides recommendations, based on performance data, for further subject intervention training that may be needed. This approach may be supported by an accredited subject teacher training solution to provide a new approach for teacher training.

Preferably, a method for producing a normalised output of a characteristic of a monitored and developing entity further comprises the step of recommunicating said first audio and/or visual communication of said test and said second audio and/or visual communication of said puppet narrator to said entity.

This configuration provides the system with a technical capability, which enables the system to retest the entity in regards to a previously asked question that was answered incorrectly. This provides a means of reiterative learning which refreshes the learning of the entity with the correct subject matter required by the question or test.

Preferably, a method for producing a normalised output of a characteristic of a monitored and developing entity further comprises the step of recalculating, from recorded information indicative of a response of said entity in respect of said one or more questions and said puppet narrator, with said processing means, a score of attainment of said entity corresponding to said one or more questions of said test.

This configuration provides the system with a technical capability, which enables the system to store the entity's recalculated score [retest] for future use.

Preferably, a method for producing a normalised output of a characteristic of a monitored and developing entity further comprises the step of communicating said puppet narrator as an avatar or animated representation.

This configuration is advantageous because it enables the system to have a technical capability that provides a puppet without the requirement of a pre-recorded film clip. Also, the avatar/animated representation may be generated in real time to narrate information to the entity, thus reducing the memory storage space required as no film recordings will be required.

Preferably, a method for producing a normalised output of a characteristic of a monitored and developing entity, further comprises the step of retrieving information indicative of additional subject matter from said information storage device to said information programming means upon the completion of said test by said entity and communicating said information of additional subject matter to said entity via a fourth audio and/or visual communication provided by said multimedia communication means.

This configuration is advantageous because it provides the entity with a technical capability that provides a sequenced structure for receiving information. This configuration will preferably not allow ordered subject matter to be communicated to the entity until the entity has completed the current test satisfactorily.

Preferably, a method for producing a normalised output of a characteristic of a monitored and developing entity further comprises the step of storing information indicative of information of a subject matter required for use in a subsequent test, which is communicated via a user interface. This configuration is advantageous because it provides a technical capability, which enables a test to drafted, amended or tailored to meet a specific of an instructor/teacher and/or curriculum, which can then be subsequently retrieved for use with an entity.

Preferably, a method for producing a normalised output of a characteristic of a monitored and developing entity further comprises the step of storing information indicative of information of an electronic document and/or film required for use in a subsequent test, which is communicated via a second user interface.

This configuration is advantageous because the subject matter contained within the system to be amended by either an instructor/teacher or parent thus providing them with a means, or technical capability, of tailoring the learning to individual or bespoke requirements of the entity.

The method preferably further comprises the step of communicating said scores to a second entity for subsequent use, via a third user interface.

This configuration is advantageous because it provides a second entity [e.g. a parent of a child] with the technical capability to gain a remote access to information which is contained within the system and indicates the current progress and performance of the entity [i.e. a student/pupil]. This therefore alerts the parent if any corrective action is required to the learning requirements of the student/pupil.

The method may further comprise the step of retrieving information indicative of a second avatar or animated representation and employing said second avatar or animated representation to communicate information indicative of the subject matter required for said test.

This configuration is advantageous because an avatar/animated representation is employed to provide the technical capability of communicating the required subject matter to an entity [i.e. a student/pupil] without the use of an instructor/teacher.

The invention also includes an apparatus adapted for producing a normalised output of a characteristic of a monitored and developing entity in accordance with any of the above steps; wherein said information storage device, said information processing means and said multimedia communication means are provided by one or more electronic components.

This configuration is advantageous because it enables the apparatus to be embodied in one or more electronic components, which form an electronic/communication system or network, thus allowing one or more components to be located remotely of other components of the apparatus.

The invention also includes a computer program comprising computer program code means adapted to perform all the steps of any of the above when run on a computer.

This configuration is advantageous because it enables the computer programme to be embodied, processed and executed on any computer and/or communication device. The computer programme may be embodied on or in a computer-readable medium.

This configuration is advantageous because it enables the computer programme to be embodied on any computer memory device, such as a disc, solid state memory devices such as flash drives or other forms of memory stick devices and mobile computer/communication devices.

### BRIEF DESCRIPTION OF THE DRAWINGS

FIG. 1 shows a top level functional block diagram that represents the functionality required for the academic teaching progress assessment system, and

FIG. 2 shows a visual display device.

### DESCRIPTION OF THE PREFERRED EMBODIMENTS

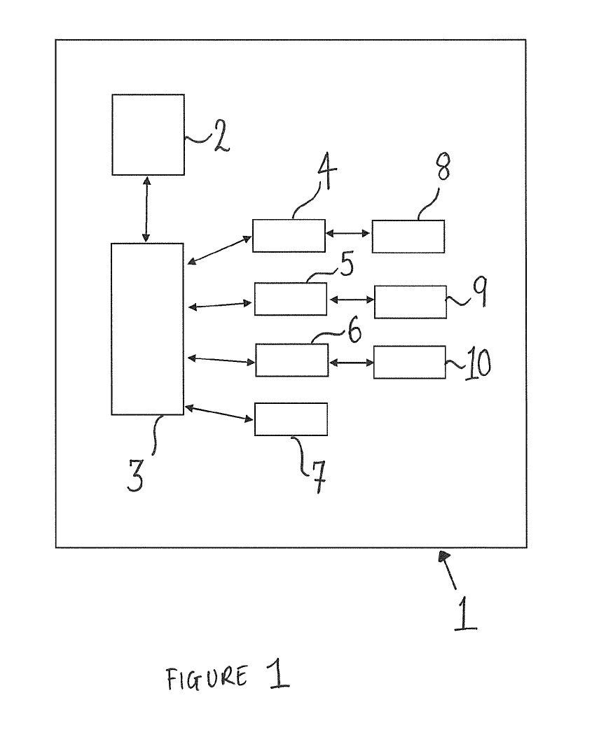

FIG. 1 shows a functional block diagram that represents the functionality required for an academic teaching progress assessment system, which is generally indicated by arrow 1.

The system 1 is a software based system which incorporates the following functional blocks shown in FIG. 1. These blocks are:
An information storage means 2;
A controlling means 3;
A pupil functional block 4;
A pupil interface 8;
A parent functional block 5;
A parent interface 9;
A teacher functional block 6;
A teacher interface 10; and
An information content functional block 7.

During the course set-up, library units can be selected in any order and from any year enabling users to design a sequenced tutor-made courses. A time-tabling feature enables courses to be created based on desired content and on variable units.

The information storage means—i.e. block 2, is a database or any other memory storage device which is implemented or connected to the other elements of the system 1. The database stores multiple lessons [also known as missions], which can then be subsequently retrieved after their selection by the user [i.e. student/pupil/parent/teacher].

The controlling means—i.e. block 3, is a controlling software element embedded within the system 1. The controlling means 3 is operably connected to the information storage means 2, whereby the controlling means 3 enables the retrieval of data/information for a required lesson from the information storage means 2. The controlling means 3 then subsequently enables the communication of data to the pupil functional block 4 which, in use, will provide and deliver the required lesson to the pupil/student user [not shown] via the pupil interface 8.

Once the required lesson has been retrieved, the software elements contained within the pupil functional block 4 comprise a multimedia functionality, which in use, will engage the pupil via the pupil graphical user interface 8.

The multimedia functionality enables the communication of the required lesson to the pupil in the form of a storytelling and/or film clip via a display and/or audio means.

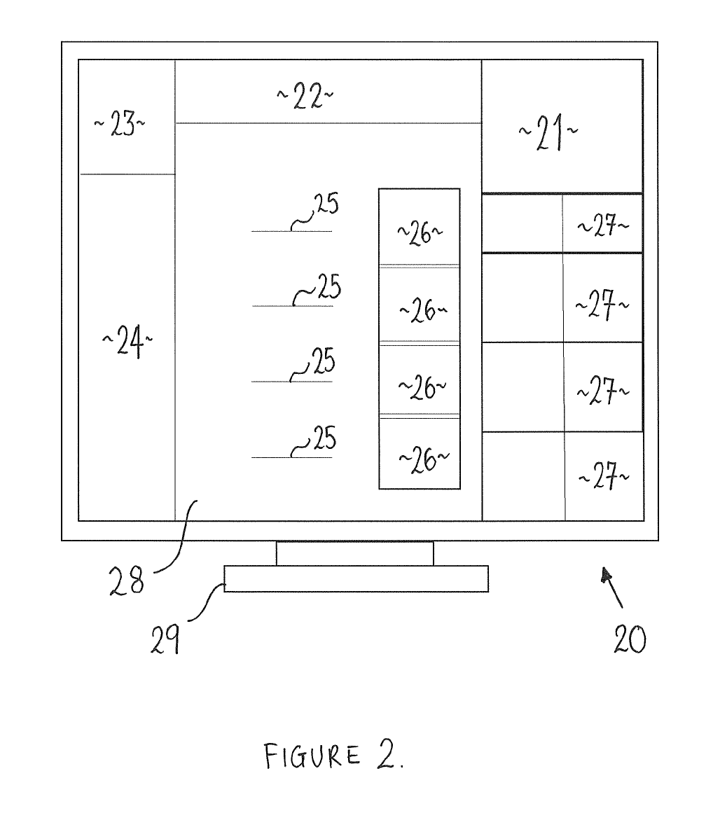

During the duration of the lesson the graphical user interface 8 will be capable of displaying the composite parts of the required lesson, via a display device (see FIG. 2) to the student/pupil user. The multimedia functionality enables a pop-up dialogue window which contains the required subject matter and/or instructions required for the lesson. The slide show may also contain a film clip that supplements the lesson, or alternatively the film clip may be presented in a second dedicated pop-up box which is also displayed to the user.

The use of embedded film is intended to embrace a hands-on learning experience, which is delivered through a range of fully demonstrated practical experiments. Thus, the films are designed to develop each learner's understanding through a variance theory approach, which means that each concept taught is explored through a number of ways.

The interface 8 enables the subject matter of the lesson to be communicated to the student/pupil user by displaying information in substantially storytelling-like manner. The data/information required for the story is retrieved by the lesson when required. The multimedia functionality provides animated characters, which communicate the key concepts of the lesson via telling a story to the user. The animated characters can exist in existing pop-up boxes within the interface 8, or within new pop-up boxes dedicated to them.

The animated characters can be inserted into an slide show presentation and/or film clip and thereby supplement the teaching of the teaching of the lesson through visual interact [i.e. additional text which may be in the form of additional dialogue boxes that represent speech, and/or an audio communication to the user via an audio communication means [speaker, headphones, wireless connection to a mobile phone or the like].

The interface 8 also incorporates a dialogue box, which is dedicated to displaying a film showing a narrator. The puppet (which in this particular instance, by way of example only, is in the visual form of, literally, a puppet—e.g. a “head and upper body” glove puppet—co-ordinates with a soundtrack (e.g. by being seen to visually speak) to explain the subject matter of the lesson, along with any key points to the pupil. The use of the puppet is an important component of the system because it retains the attention of the student/pupil user for prolonged periods throughout the duration of the lesson, in particular, those users of a very young age. Such puppet images, with a visual and/or audio-visual output provide an improved means for conveying the subject matter of the lesson to the user.

All the data information for the required films, presentation and animated characters is contained within a data structure in which they are correlated to the required lesson and can be retrieved, when required, by the user. The films are thus intended to provide lessons/experiments, which are engaging and fun.

When a lesson has finished or completed, the controller 3, via the interface 8, will then generate a pop-up dialogue box, which contains a set of questions in the form of a test/quiz, which will then examine the student/pupil's knowledge on the subject matter and key points of the completed lesson. The puppet narrator is also used to explain the subject matter of the test, again the purpose of the puppet is to ensure that the interface 8 has the attention of the student/pupil user. Once again, the puppet provides an improved means of conveying the requirements of each test/quiz to the user.

If the student/pupil answers incorrectly to any of the questions, the controller 3 via the interface 8 will generate a new dialogue box, which will display a slide show presentation and/or film that is related to the incorrectly answered element.

Thus, a purpose of the film and/or the slide show presentation is to correct the student to repeat the communication of information, which teaches the user the correct answer to the correction. This is an iterative learning technique, which is also known as a space repetitive technique [which is a complex form of the conventional “flash card” technique of learning]. Once completed, the controller has the option of guiding the pupil back to the test to re-answer the question before proceeding to other subsequent questions within the test. Or, alternatively, the controller can guide the student straight to the next question within the test without any corrective action.

Thus, the tests are so provided as to maximise and track the retention of the knowledge gained from the lesson by the user.

When a test has been completed, the controller stores the student/pupil's achievements within the database 2 for subsequent use. When required, the controller will generate a new dialogue box which contains a certificate of achievement, upon which the level of attainment is shown. The level of attainment is dependent upon the score acquired by the student/pupil user. Once raised the certificate can then be stored electronically or printed off in paper from via printing device connected to the system 1.

Once completed, the controller will enable/unlock other lessons available to the pupil, so that the student/pupil's learning can be structured in a sequenced and organised manner [i.e. according to their current record of learning attainment], which can then be subsequently mapped against the required curriculum.

When required, the controller 3 may generate one or more pop-up dialogue boxes, which incorporate electronic documents, such as tables, spread sheets, calendars, handouts and text editors, which are supplementary to the subject of the lesson.

The controlling means 3 is operably connected to the parent block 5; this enables the communication of data to parent functional block 5 which contains software elements that, in use, will provide and deliver the information requested by the parent in regards to the student/pupil, via the parent interface 9. For example, if the pupil is not making the required progress, the controller 3 will initiate a communication which informs the parent of a student/pupil user of the current progress of the user. This communication may be in the form of an automatically generated email, or text/audio message, sent over a mobile network (i.e. Short Message Service [SMS] and/or Multimedia Messaging Service [MMS]), or by the platforms that can function.

Furthermore, the parents of the pupil will be able to access a library of pre-structured and sequenced lessons, which are intended to provide a solution to educating the pupil in the home environment. The library is be stored within the database 2 or alternatively in an internet based computer resource, which is also known as “Cloud Computing” or “On Demand Computing”, any of which will enable remote access to the lesson for subsequent updating or removal.

The parent can thus select the relevant mission/lesson for a parent interface 9 and, when selected, the lesson will be retrieved from the database 2 for subsequent use by the system 1. The parent(s) of the pupil can also select the academic level of lesson, which they believe is suitable for the pupil.

The controller 1 also has a means of providing an overview of the required curriculum for a student/pupil. The curriculum information is stored within the database of the system 1, or alternatively is available via an interface to an external information resource which is external to the system 1. When teaching at home, the controller enables the parent to provide slideshow representations, which have been organised and structured to provide a lesson on a given subject at the required academic level. Furthermore, the parent interface 9 will generate a pop-up dialogue box which contains a text editing means that allows the parent to amend, restructure or draft a slide show presentation to their own requirements.

The software elements within the parent block 5 will enable the parent to generate an update schedule via the parent interface 9 which provides a means of regularly updating parents in regards to the pupil's progress and learning.

The controlling means 3 is operably connected to the teacher block 6, this enables the communication of data to the teacher functional block 6, which contains software elements that, in use, provide a solution to the teacher requirements of the system 1, along with the multimedia functionality required for communicating to the teacher. The controlling means 3 enables the teacher to structure and amend the contents of the mission/lesson. This can be achieved by the teacher selecting and embedding the components within the structure via a graphical user interface 10. These components can be slideshow presentations, film clips and/or supplementary literature. Once the lesson/mission has been completed/structured, it is then stored in the database for subsequent retrieval. This enables the teacher to correct a lesson in response to any of the improvements which may be required to existing lessons/missions.

In addition to the lessons to the pupils, Continued Professional Development (CPD) lessons may be circulated to the teacher via the system 1, for subsequent independent use by the teacher. The teacher functional block 6 may also track and register which teachers have received a CPD update, i.e. via an electronic ledger which logs who has received an update, and who has been subsequently assessed for CPD scoring.

Thus, the teacher functional block 6 provides:
Possibility to deliver schemes of learning with fully resourced lessons, which include a lesson plan, slideshow presentation, handout, quiz, film and occasional learning songs.
Access to a complete primary solution and tracked CPD training resources, which develop their subject expertise.
Immediate feedback which tracks each pupil's learning and performance and
Summary reports.

The teacher functional block 6 also provides the teachers with a means of building a timetable for a selected subject. Thus, the controlling means 3 will provide a graphical user interface which allows the user to drop a resource into the lesson and date slot.

The resource may be in the form of any one of the following:
A plan;
A spiral test;
A slide presentation;
A worksheet;
A homework sheet;
A mission film;
A careers film;
An interview with an expert;
A CPD training film; and
A quiz.

The controlling means 3 is operably connected to the information content functional block 7, which includes means for controlling the system's content and enables the system 1 to be implemented on a mobile communication device/platform [i.e. mobile computer devices such as tablet computers and “smart” mobile phones]. This makes it easier for parents to obtain an update in regards to the student's performance without having to wait until e.g. the traditional scheduled parent's evening.

The system 1 may be embodied in a software application for a mobile device, e.g. the Android™ or IOS App™ formats, thus enabling parents to schedule a request for an update as often as they like, daily, weekly, monthly, etc. in real time.

The system 1 may also provide a teacher with an interface which provides an image capture of the pupil's last work that can then be uploaded to the system 1. This can be achieved through the use of a digital camera in a smart mobile phone via a wireless or cable based communication network. The teacher then has the option of publishing the photographs to the parents via the App.

Furthermore, primary teachers have been expected to teach subjects as non-specialists for quite some time now. This can result in teachers spending hours creating and planning sufficient lessons independently and having to “re-invent the wheel”. Therefore, the system 1 will enable teachers to have access to a complete primary education solution and CPD training resource, which develops their subject expertise without any unnecessary duplication.

In use, the invention provides a technical solution to the following technical problems/solution scenarios:
Provides an automated solution to the problem of teaching and/or testing of student/pupils which may have a low attention span, such student/pupils being of e.g. a young age or with learning difficulties. It retains their attention for the duration of a lesson or test without the involvement of an instructor/teacher, which is otherwise problematic.
Provides an automated solution to the problem of retesting a student/pupil who may have a low attention span, and ensuring that any subject matter which has yet to be learnt is communicated to the pupil/student without the involvement of a sole instructor/teacher.
Provides an automated solution to the problem of enabling a parent/guardian of a student/pupil to have access to information in regard to the learning achievements of a student/pupil without the involvement of an instructor/teacher.
Provides an automatic solution to the problem of enabling the communication of CPD requirements to instructors/teachers without the involvement of additional CPD instructors/teachers.

Turning next to FIG. 2, this shows a visual display device, which is generally indicated by arrow 20. The display device displays the following elements of the invention to the student/pupil entity:
A multimedia—audio/visual channel 21 which displays and communicates information from a puppet narrator to the student/pupil entity;
A text based dialogue box 22 which communicates text-based information which summarises the objective/purpose lesson/test to the student/pupil entity;
A symbol box 23 which communicates the general field of the subject matter of the lesson/test;
One or more text boxes 24 which communicate score metrics, obtained, to be obtained for the next achievement level;
One or more questions 25 for a given test/quiz for testing the student/pupil for a given subject area;
One or more multimedia—audio/visual channels 26 which display and communicate information in regard to the question 25 to the student/pupil entity, some of which may be selectable when responding to the question; and
A multimedia—audio/visual channel 27 which displays and communicates information for a number of selectable options to the student/pupil entity;
A themed back drop display 28 in relation to the subject matter of the lesson/test to the student/pupil entity. The back drop may also comprise an avatar/animated character for supplementing the communication of the information of the lesson/test to the user; and
A stand 29 for the display device.

In the description of the preferred embodiment this narrator is in the form of a visual and/or audio-visual image of, literally, a puppet character.

What is claimed is:

1. A method for producing a normalised output of a characteristic of a monitored and developing entity, said method comprising the steps of:
intermittently retrieving information indicative of a test from an information storage device to an information processing means; and
communicating information indicative of one or more questions of said test from said processing means to said entity via a first audio and/or visual communication provided by a multimedia communication means;
said method being characterised in that it includes the further steps of:
communicating information indicative of an audio and/or visual communication that provides a narrator, which in use, communicates said test to said entity via a second audio and/or visual communication provided by said multimedia communication means;
calculating, from recorded information indicative of a response of said entity to said one or more questions and said narrator, with said processing means, a score of attainment of said entity corresponding to said one or more questions of said test; and
outputting said score as a measure of attainment of said entity in response to said test.

2. The method according to claim 1, further comprising the step of retrieving information indicative of the subject matter for providing a correct response to a question if said entity provides an incorrect response to said question, and communicating said information of correct response to said entity via a third audio and/or visual communication provided by said multimedia communication means;

3. The method according to claim 2, further comprising the step of recommunicating said first audio and/or visual communication of said test and said second audio and/or visual communication of said puppet narrator to said entity.

4. The method according to claim 3, further comprising the step of recalculating, from recorded information indicative of a response of said entity to said recommunications from said one or more questions and said puppet narrator, with said processing means, a score of attainment of said entity corresponding to said one or more questions [QUESTIONS] of said test

5. The method according to claim 1, further comprising the step of communicating said puppet narrator as an avatar or animated representation.

6. The method according to claim 1, further comprising the step of retrieving information indicative of additional subject matter from said information storage device to said information programming means upon the completion of said test by said entity and communicating said information of additional subject matter to said entity via a fourth audio and/or visual communication provided by said multimedia communication means.

7. The method according to claim 1, further comprising the step of storing information indicative of information of a subject matter required for use in a subsequent test, which is communicated via a user interface.

8. The method according to claim 1, further comprising the step of storing information indicative of information of an electronic document and/or film required for use in a subsequent test, which is communicated via a second user interface.

9. The method according to claim 1, further comprising the step of communicating said scores to a second entity for subsequent use, via a third user interface.

10. The method according to claim 1, further comprising the step of retrieving information indicative of a second avatar or animated representation and employing said second avatar or animated representation to communicate information indicative of the subject matter required for said test.

11. An apparatus for producing a normalised output of a characteristic of a monitored and developing entity in accordance with the method claimed in claim 1; wherein said information storage device, said information processing means and said multimedia communication means is provided by one or more electronic components.

12. A computer program comprising at least one processor, and at least one memory including computer program code, the at least one computer readable medium and the computer program code configured to, with the at least one processor, perform all the steps of claim 1.

13. (canceled)
